(19) United States
(12) Patent Application Publication
(10) Pub. No.: US 2025/0253108 A1
(43) Pub. Date: Aug. 7, 2025

(54) MULTI-LAYERED KEYBOARD ALIGNMENT AND COMPRESSION FIXTURE AND METHOD

(71) Applicant: Logitech Europe S.A., Lausanne (CH)

(72) Inventor: Ouyang Simon Chase, Hsinchu City (TW)

(21) Appl. No.: 18/434,384

(22) Filed: Feb. 6, 2024

(51) Int. Cl. H01H 13/88

(52) U.S. Cl. CPC H01H 13/88

(57) ABSTRACT

An apparatus for assembling an electronic device having multiple internal layers. A first plate has a plurality of guides to align the multiple internal layers. A second plate has a resilient surface with a plurality of indentations shaped to engage protruding features of the multiple internal layers. A press is removably attachable to one of the first and second plates, to compress the multiple internal layers between the first and second plates. A method is shown for assembling an electronic device having multiple internal layers. A first step is using a guide is used to align the multiple internal layers. A second step is compressing the multiple internal layers using a press A third step is fastening the multiple internal layers together using a plurality of fasteners, to form a subassembly. A fourth step is mounting the subassembly into an electronic device housing.

### BACKGROUND OF THE INVENTION

The present invention relates to assembling multi-layered electronic devices, in particular keyboards with compressible layers for sound absorption.

Many keyboards are multi-layered. During assembly, alignment guides ensure that the layers are properly placed over each other in the correct position. Typically, the layers are then fixed using screws in screw holes that connect to a bottom plate of the keyboard. Some modern keyboards add foam or other compressible layers to damping the clicking noise of the keyboard keys. When screwing through these layers, there can be movement or bending of the foam layer. Also, the layer can be compressed different amounts if the different screws are not uniformly secured. This results in differences in sound dampening between areas where the foam layer is smooth and areas where the foam has been scrunched up. It would be desirable to have an improved assembly method that avoids these issues.

Unless otherwise indicated herein, the materials described in this section are not admitted to be prior art by inclusion in this section.

### BRIEF SUMMARY OF THE INVENTION

Embodiments of the invention provide an apparatus for assembling an electronic device having multiple internal layers. A first plate has a plurality of guides to align the multiple internal layers. A second plate has a resilient surface with a plurality of indentations shaped to engage protruding features of the multiple internal layers. A press is removably attachable to one of the first and second plates, to compress the multiple internal layers between the first and second plates.

In embodiments, the guides are guide pins which extend through holes in the multiple internal layers. The first plate has an array of pegboard holes providing multiple locations for placement of the guide pins for different size electronic devices. In one embodiment, the electronic device is a keyboard and the protruding features are keyboard switches. The first plate has a metal layer and a rubber layer. The second plate has a rubber layer as the resilient surface and also includes a metal layer and a foam layer. The plurality of indentations extend through the rubber layer to the foam layer.

Embodiments of the invention provide a method for assembling an electronic device having multiple internal layers. A first step is using a guide is used to align the multiple internal layers. A second step is compressing the multiple internal layers using a press A third step is fastening the multiple internal layers together using a plurality of fasteners, to form a subassembly. A fourth step is mounting the subassembly into an electronic device housing.

Embodiments of the invention provide even compression, before fastening, of the multiple internal layers. This allows the use of thinner foam (sound dampening) layers that otherwise might be scrunched up during the fastening process. Additionally, it allows the introduction of fabric layers, which have even better sound absorption properties, but are hard to work with to keep even.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIG. 1 is a diagram of a multi-layered keyboard that can be assembled using embodiments of the present invention.

FIG. 2 illustrates the internal keyboard layers between two plates of a press apparatus, according to embodiments.

FIGS. 3A-C are diagrams illustrating the top plate of the press, showing the bottom of the top plate in FIG. 3A, and the top of the top plate in FIG. 3B, with detail of a guide pin in FIG. 3C, according to embodiments.

FIGS. 4A-D are diagrams illustrating the bottom plate of the press, with details of a guide pin in FIG. 4B and details of a cavity in FIGS. 4C-D, according to embodiments.

FIG. 5 is a diagram of a removable bottom plate and a press support used to hold the bottom plate, according to embodiments.

FIGS. 6A-C are diagrams of a removable top plate and a press support used to hold the top plate, according to embodiments.

FIG. 7 is a diagram of a top press plate and a bottom press plate with a thick, central guide pin, according to embodiments.

FIGS. 8A-8C are diagrams illustrating a mechanical mechanism for applying pressure to the press plates, according to embodiments.

FIG. 9 is a diagram of a press column with a press stop, according to embodiments.

FIG. 10 is a flowchart of a method for forming a keyboard layer subassembly, according to embodiments.

Throughout the drawings, it should be noted that like reference numbers are typically used to depict the same or similar elements, features, and structures.

### DETAILED DESCRIPTION OF THE INVENTION

Aspects of the present disclosure relate generally to assembling multi-layered electronic devices, in particular keyboards with compressible layers, according to certain embodiments.

In the following description, various examples of assembling multi-layered keyboards with compressible layers are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in the below description in order to prevent any obfuscation of the novel features described herein.

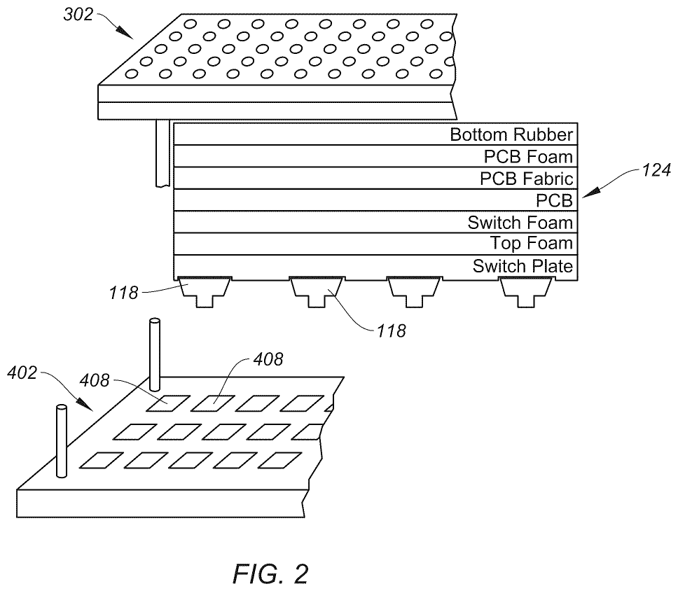

The following high-level summary is intended to provide a basic understanding of some of the novel innovations depicted in the figures and presented in the corresponding descriptions provided below. Aspects of the invention relate to an apparatus for assembling an electronic device having multiple internal layers using two plates and a press. FIG. 2 illustrates a first, top plate 302 for compressing multiple internal electronic device layers as a subassembly 124. The layers are compressed by top plate 302 against a bottom plate 402. Indentations 408 accommodate protrusions in the electronic device, such as switches on a switch plate layer of a keyboard.

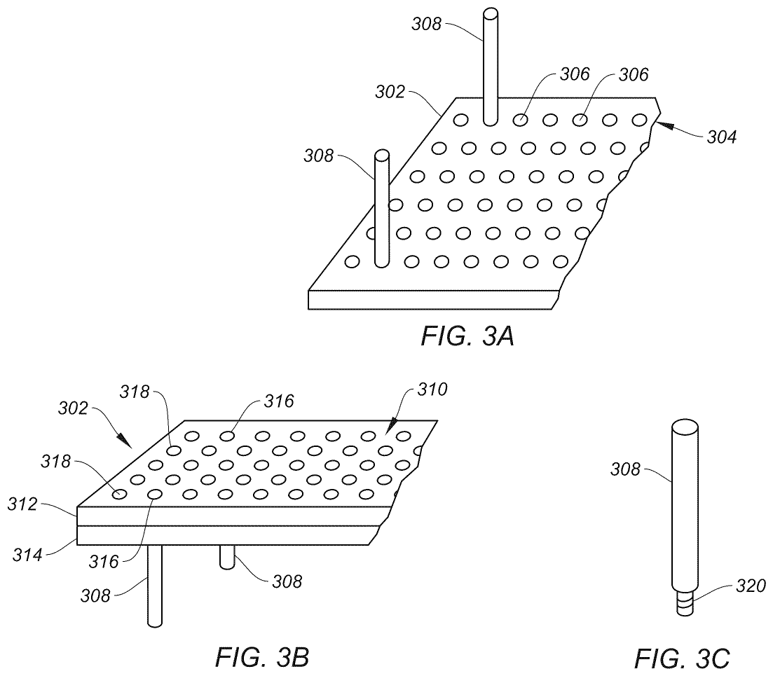

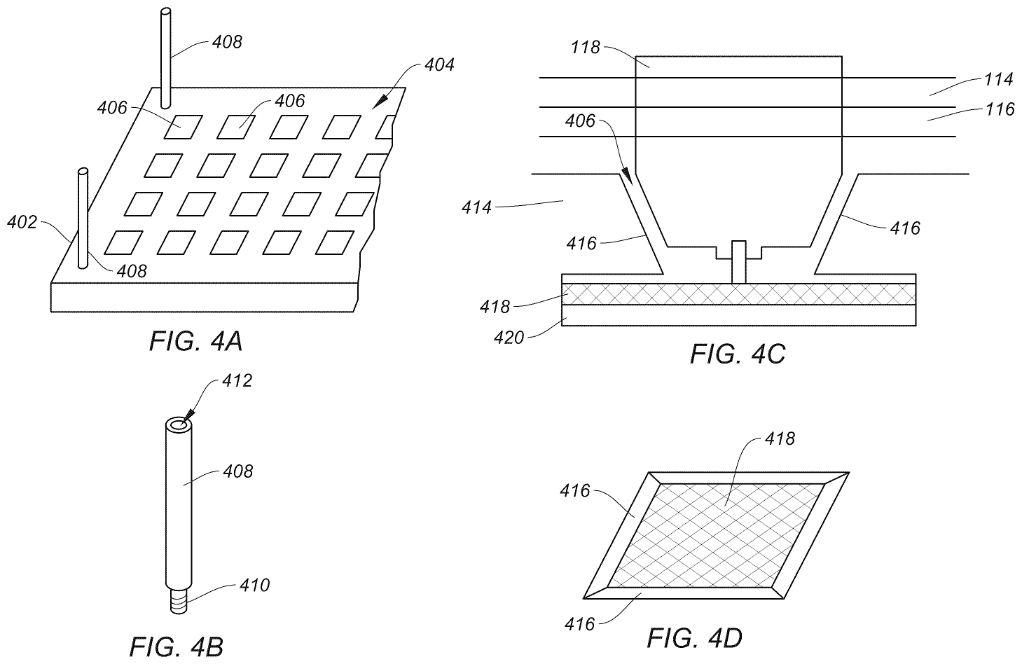

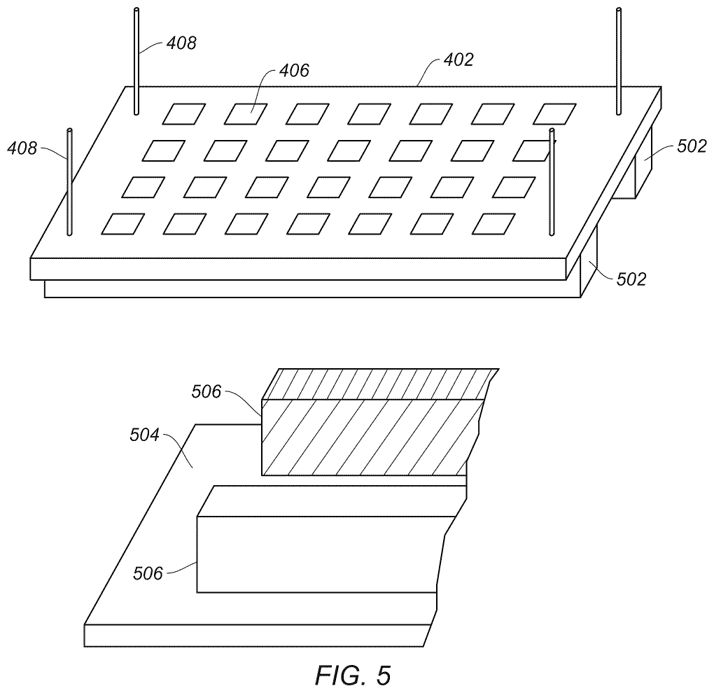

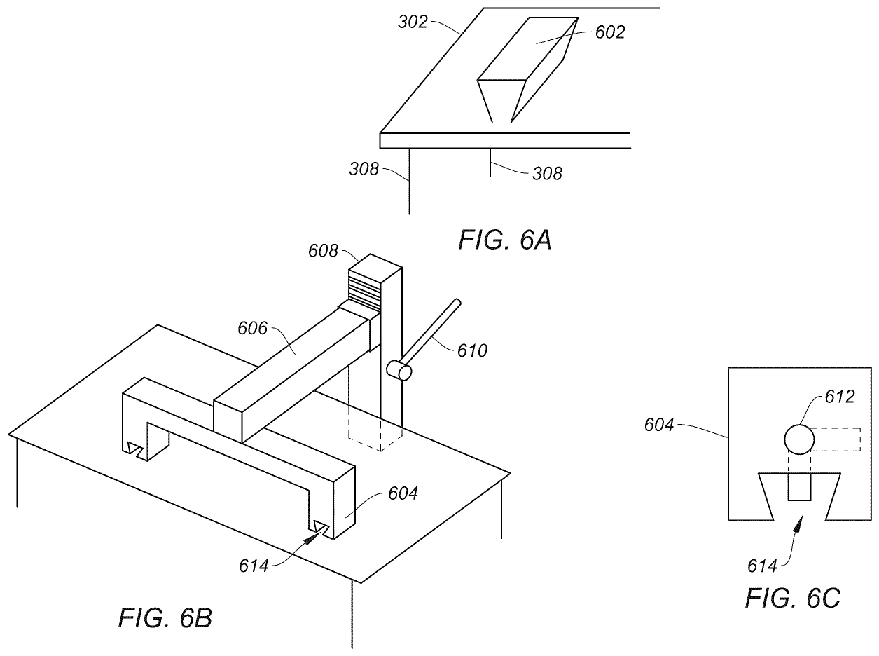

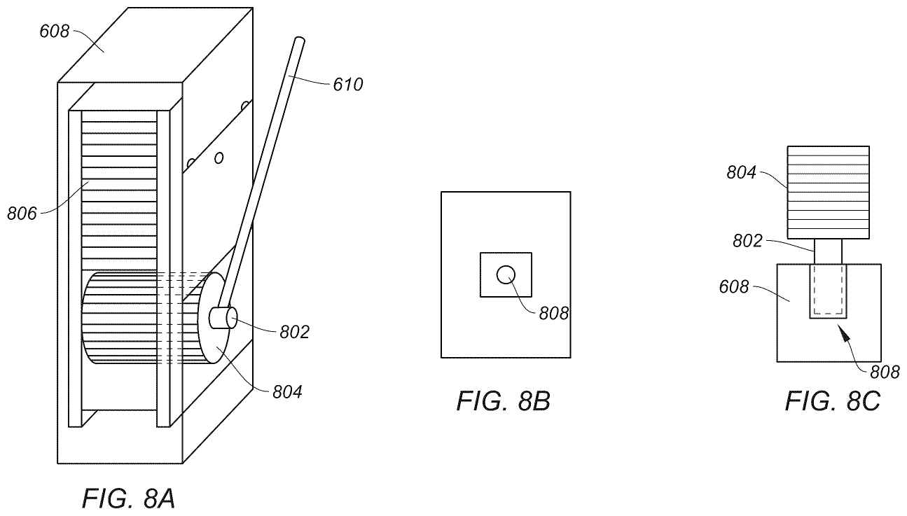

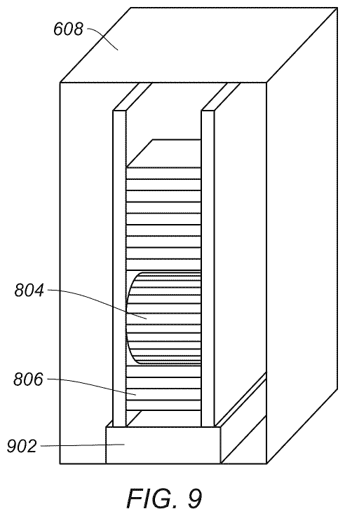

The top plate is illustrated in more detail in FIGS. 3A-C, and the bottom plate in FIGS. 4A-D. FIGS. 5 and 6 illustrate rails 506 on a bottom press support structure of the press for engaging the bottom plate and rails 602 on the top plate for engaging with a press arm 604. FIGS. 8-9 illustrate an exemplary press mechanism for compressing the plates with the electronic device internal layers in between.

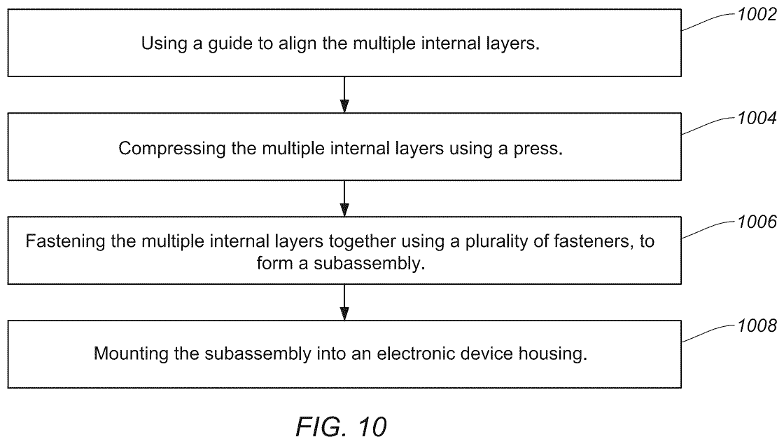

The method for assembling the electronic device multiple internal layers as a subassembly, then fastening the subassembly into a device housing, is illustrated in the flowchart of FIG. 10.

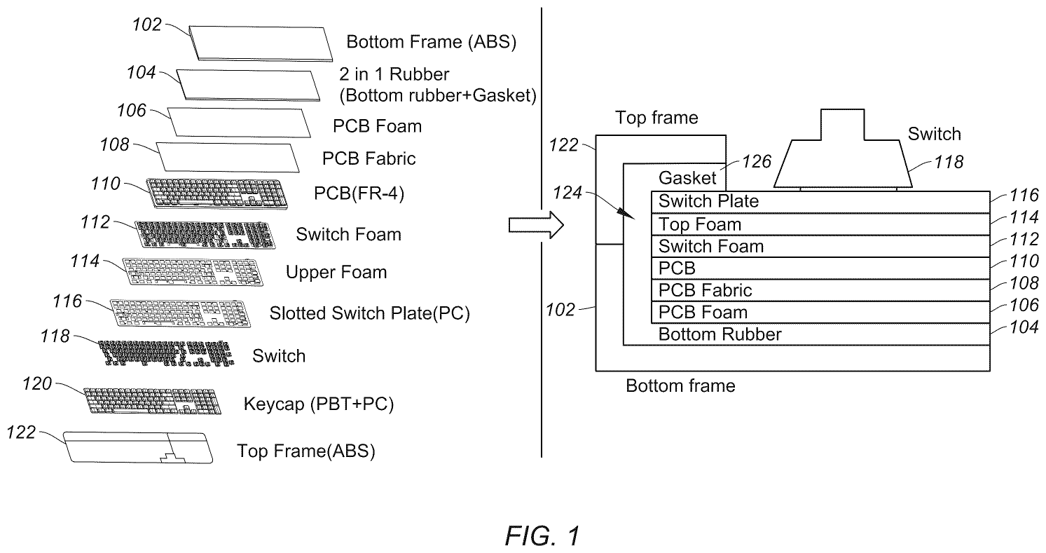

FIG. 1 is exploded and assembled diagrams of a multi-layered keyboard that can be assembled using embodiments of the present invention. The keyboard has a bottom frame 102 and top frame 122. Using embodiments of the invention, internal layers 104-118 are stacked, compressed, and fastened together to form a subassembly 124. The subassembly then has keycaps 120 attached, and is mounted between bottom frame 102 and top frame 122.

The subassembly 124 includes a rubber layer 104 that forms a bottom layer, and folds around the other layers in the subassembly at the edges to form a top gasket 126 as shown in FIG. 1B. The other layers of the subassembly are PCB foam 106, PCB fabric 108, PCB 110, switch foam 112, upper foam 114, slotted switch plate 116 and switches 118. Keycaps 120 are added after the subassembly is formed, and before mounting the subassembly between the bottom and top housings. The subassembly can be mounted in the housings by screwing it into one of the top or bottom housing, then screwing and/or gluing together the top and bottom housing.

Embodiments of the invention allow the use of fabric layer 108, which otherwise is very difficult to keep flat and even. Fabric has great sound attenuation qualities. But with traditional assembly practices, it has a tendency to scrunch up and thus provide uneven or distorted sound attenuation qualities, and thus is not typically used.

Embodiments of the invention compress the internal layers 104-118 between two plates of a press apparatus. FIG. 2 illustrates the internal keyboard layers between two plates of a press apparatus, according to embodiments. The internal keyboard layers are turned upside-down and sandwiched between two plates of a press, an upper plate 302 and a lower plate 402. Lower plate 402 has an upper surface of rubber with cavities 408 for accommodating switches 116 on the switch plate 116. The keyboard layers are inverted because inverting the assembly allows for gravity to assist with a downward push force during assembly. Inversion also prevents the plunger from pressing down on the switches directly, avoiding damage to the switch pins and spring assembly. In addition, inversion allows for an even compression of the layers to level and push out air pockets caused by uneven placement.

FIGS. 3A-C are diagrams illustrating the top plate 302 of the press, showing it upside down in FIG. 3A, with the bottom 304 of the top plate visible, and the top 310 of the top plate in FIG. 3B, according to embodiments. As shown in FIG. 3A, there is an array of holes 306 for accepting guide pins 308, in a pegboard arrangement. The guide pins 308 can be placed in different arrangements depending on the size and shape of the keyboard layers being assembled. The guide pins 308 extend through holes (not shown) in the layers themselves at different points to maintain all the layers in alignment. Alternately, other methods of alignment could be used, although they may be more costly. For example, lasers could be used to guide the assembler or assembly machine in placement of the multiple layers.

As shown in FIG. 3B, the top plate is flipped over from the view of FIG. 3A to show the top 310 of top plate 302. There are two layers to the top plate, a metal layer 312 and a rubber or other resilient layer 314 to gently engage an outer layer of the internal keyboard layers. The metal layer 312 also has pegboard holes 316 aligned with holes 306 illustrated in FIG. 3A. Outside of the pegboard holes 316 (used for guide pins 308) are screw holes 318. These holes are used to insert screws in order to fasten together the internal keyboard layers after they are pressed together, to form the subassembly.

FIG. 3C illustrates an embodiment of guide pin 308 from FIGS. 3A-B. Guide pin 308 has a bottom threaded portion 320 for engaging with a guide pin of a bottom plate, as illustrated in the subsequent figures. In an alternate embodiment, the threaded portion 320 can engage with a threaded hole in the bottom plate, rather than a corresponding guide pin.

FIGS. 4A-D are diagrams illustrating the bottom plate 402 of the press, with details of a guide pin 408 in FIG. 4B and details of a cavity 406 in FIGS. 4C-D, according to embodiments. Bottom plate 402 has a top surface 404 made of rubber or other resilient material, with cavities 406 shaped to engage and support the switches of the switch plate. Guide pins 408 engage with the guide pins 308 of upper plate 302 to align the keyboard inner layers.

FIG. 4B is a diagram illustrating more details of a guide pin 408. The bottom of guide pin 410 has threads 410 for screwing into holes of bottom plate 402. These holes are positioned to be below the desired alignment guide pins of the upper plate, with the alignment being for the particular size and shape of keyboard being assembled. A female threaded hole 412 at the top of guide pin 408 engages the threaded bottom 320 of upper plate guide pin 308 as shown in FIG. 3C. Alternately, threaded hole 412 can be part of bottom plate 402, so that upper plate guide pin 308 screws directly into the holes of the bottom plate. The bore hole design allows for a highly accurate alignment without the use of high cost and complex sensors or lasers.

FIG. 4C is a cross-sectional view illustrating a rubber layer 414 with a cavity 406 for engaging a switch 118. The cavity has angled walls 416 to conform to the shape of switch 118. The walls are angled more at the bottom of the cavity, narrower than the switch, so that the walls are deformed as the switch is pushed down into the cavity. This causes the walls of the cavity to grip and hold the switch in place. The figure shows the walls as wider to show the walls clearly compared to the switch, but would actually be narrower than shown.

In some embodiments, the cavities or indentations do not need to mirror the switch shape, but are wider at the top than at the bottom. The wider top allows insertion of the switches, while the narrower bottom allows the resilient layer to grip and hold the switches in alignment during compression. In one embodiment, the indentations mirror the shape of the switches, and are 0.3-2.0% smaller to provide the desired gripping effect.

The bottom of the cavity has a soft foam layer 418 to engage and cushion the end of the switch without damaging the switch. The foam is over a metal layer 420. Thus, the bottom plate has three layers, metal layer 420, foam layer 418 and rubber layer 414. When the keyboard internal layers are placed over the bottom plate, the protruding switches are pressed into cavities 406, with the top of the switch being protected by foam layer 418. The foam layer can be a fail-safe, with the switch not normally being in contract, or the cavity can be sized so that the switch will engage the foam layer to provide additional stability and alignment with an additional point of contact.

FIG. 4D is a top view of cavity 406 of FIG. 4C. The four angled sides 416 of cavity 406 can be seen, along with the foam layer 418 at the bottom of the cavity. Bottom plate 402 is customized for each type of keyboard. Thus, a number of bottom plates can be used, each corresponding to a particular size and shape of a keyboard. In embodiments, the bottom plate is removable from the press apparatus, so that the same press apparatus can be used for different shaped keyboards. The top plate can simply have the guide pins moved, while the bottom plate is entirely replaced.

FIG. 5 is a diagram of a removable bottom plate and a press support used to hold the bottom plate. Bottom plate 402 is shown, with rails 502 extending from the bottom metal layer. The bottom plate is placed over a press support structure 504 have support rails 506, which engage the gap between rails 502 of the bottom plate. The rails prevent sideways movement when the keyboard inner layers are compressed in the press. Alternate structures could be used as well. For example, the rails could be angled, as shown for the top rails shown in FIGS. 6A-C.

FIGS. 6A-C are diagrams of a removable top plate and a press support used to hold the top plate, according to embodiments. FIG. 6A shows top plate 302 with guide pins 308. Attached to the top of top plate 302 is a rail 602 with an inverted pyramid shape. Not shown is a second, parallel rail. Rail 602 engages with a similarly shaped slot 614 in a press bar 604 as shown in FIGS. 6B-C. Press bar 604 is supported on a press column 608, which can be cranked downward to apply pressure using a crank handle 610. The shaped slot 614 of arm 604 ensures that top plate 302 will not slide sideways when the keyboard layers are compressed. A locking mechanism 612 shown in FIG. 6C ensures that the top plate and its rails do not slide out of slot 614. The direction of rails 602 can be orthogonal to the direction of the rails of the bottom plate, further providing stability in both orthogonal directions.

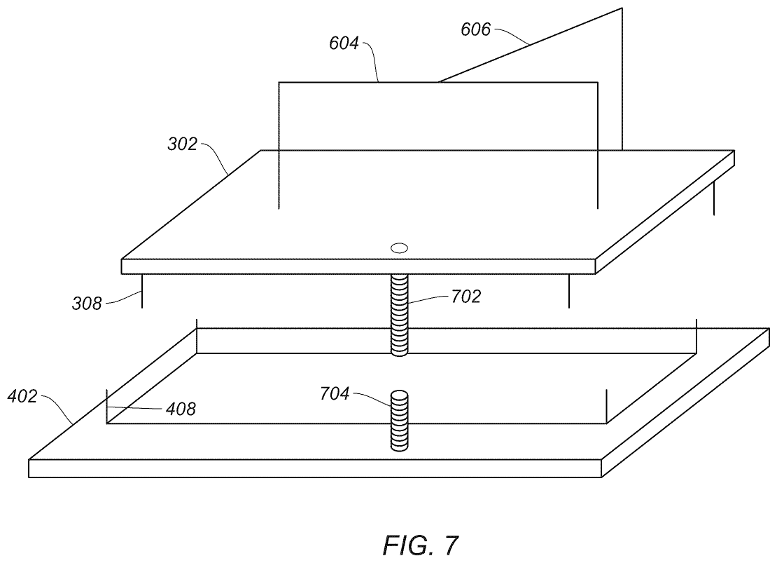

FIG. 7 is a diagram of a top press plate and a bottom press plate with a thick, central guide pin or pillar, according to embodiments. Top plate 302 has guide pins 308 which engage with guide pins 408 of bottom plate 402, as discussed previously. In addition, thicker guide pins/pillars 702 and 704 are provided near the center of the plates to provide additional stability. This insures alignment of the plates before full compression of the keyboard internal layers. The keyboard layers would have corresponding holes in the center, so that the guide pins/pillars could pass through the holes. Depending on the layout of the keyboard layers, it may be desirable to place the holes at other that the exact center of the keyboard layers.

In alternate embodiments, the guide pins could be placed outside, and adjacent, the perimeter of the keyboard layers. This could be combined with other features, such as ridges, walls, or indentations to position and align the layers before compression.

The amount of full compression is determined by examining the quality of the keyboards after using different amounts of compression to assemble the subassembly in a pre-production process. Thereafter, the ideal pressure for obtaining the ideal sound absorption and keyboard operation properties can be determined and used to set the desired pressure on a manual pressure gauge or an automatic stop for an automatic compressor.

FIGS. 8A-8C are diagrams illustrating a mechanical mechanism for applying pressure to the press plates, according to embodiments. FIG. 8A shows press column 608 of FIG. 6B, and crank handle 610. Crank handle 610 connects to an axle 802 of a gear roller 804. The ridges of gear roller 804 engage with ridges of a linear gear 806, causing press column 608 to move up and down as the crank handle 610 is rotated.

FIG. 8B shows a hole 808 in press column 608 opposite crank handle 610 for supporting axle 802. A top view is shown in FIG. 8C, with axle 802 protruding beyond gear 804 into hole 808.

FIG. 9 is a diagram of a press column with a press stop, according to embodiments. A press stop 902 keeps the arm 606 of FIG. 6B from descending too far, thus preventing over torque which can crush and damage the internal keyboard layers.

Although a mechanical press has been described, other types of presses could be used. For example an air pressure or pneumatic press could be used. Alternately, an oil pressure press could be used.

FIG. 10 is a flowchart of a method for forming a keyboard layer subassembly, according to embodiments. FIG. 10 illustrates a method for assembling an electronic device having multiple internal layers. Step 1002 is using a guide to align the multiple internal layers. Step 1004 is compressing the multiple internal layers using a press. Step 1006 is fastening the multiple internal layers together using a plurality of fasteners, to form a subassembly. Step 1008 is mounting the subassembly into an electronic device housing.

### Alternate Embodiments

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

For example, the apparatus and method of the described embodiments and claimed invention could be applied to assembling different internal layers of a computer mouse. The indentations or cavities could be shaped to accommodate the mouse switches and a roller, instead of keyboard switches.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. An apparatus for assembling an electronic device having multiple internal layers, comprising:
a first plate having a plurality of guides configured to align the multiple internal layers;
a second plate having a resilient surface with a plurality of indentations shaped operable to engage protruding features of the multiple internal layers; and
a press, removably attachable to one of the first and second plates, configured to compress the multiple internal layers between the first and second plates.

2. The apparatus of claim 1 wherein the guides comprise guide pins which extend through holes in the multiple internal layers.

3. The apparatus of claim 2 wherein the first plate has an array of pegboard holes providing multiple locations for placement of the guide pins for different size electronic devices.

4. The apparatus of claim 1 wherein the electronic device is a keyboard and the protruding features are keyboard switches.

5. The apparatus of claim 1 wherein the first plate has a plurality of rails and the press further comprises:
an arm having a plurality of slots configured to engage the plurality of rails of the first plate.

6. The apparatus of claim 1 wherein the first plate comprises a metal layer and a rubber layer.

7. The apparatus of claim 1 wherein the resilient surface of the second plate comprises a rubber layer, and the second plate further comprises a metal layer and a foam layer.

8. The apparatus of claim 7 wherein the plurality of indentations extend through the rubber layer to the foam layer.

9. The apparatus of claim 1 wherein the guides comprise first guide pins extending from the first plate and second guide pins extending from the second plate, and wherein the first and second guide pins attach to each other.

10. The apparatus of claim 1 wherein the guides comprise guide pins positioned near a periphery of the multiple internal layers, and further comprising a guide pillar connected to the first plate, the guide pillar being thicker than the guide pins and positioned centrally with respect to the guide pins.

11. An apparatus for assembling a keyboard having multiple internal layers, comprising:
a first plate having a plurality of first guide pins to align the multiple internal layers, the first guide pins extending through holes in the multiple internal layers, wherein the first plate has an array of pegboard holes providing multiple locations for placement of the first guide pins for different size keyboards;
wherein the first plate comprises a first plate metal layer and a first plate rubber layer;
a second plate having three layers including a second plate rubber layer with a plurality of holes shaped to engage protruding switches of the keyboard, the holes extending to a foam layer which cushions the switches, and the foam layer being mounted on a second plate metal layer; and
a press, removably attachable to one of the first and second plates, configured to compress the multiple internal layers between the first and second plates.

12. The apparatus of claim 11 wherein the first plate has a plurality of rails and the press further comprises:
an arm having a plurality of slots configured for engaging the plurality of rails of the first plate.

13. The apparatus of claim 11 further comprising:
second guide pins extending from the second plate, wherein the second guide pins attach to the first guide pins.

14. The apparatus of claim 11 wherein the holes are wider at a top portion and are narrower than the switches near a bottom portion, to provide a compression grip on the switches.

15. A method for assembling an electronic device having multiple internal layers, comprising:
using a guide to align the multiple internal layers;
compressing the multiple internal layers using a press;
fastening the multiple internal layers together using a plurality of fasteners, to form a subassembly; and
mounting the subassembly into an electronic device housing.

16. The method of claim 15 wherein the electronic device is a keyboard.

17. The method of claim 16 further comprising:
compressing the multiple internal layers between first and second plates; and
engaging a plurality of switches on a layer of the keyboard with holes in a rubber layer of the second plate.

18. The method of claim 17 wherein using a guide comprises inserting a plurality of guide pins through the first plate and a plurality of holes in the multiple internal layers.

19. The method of claim 18 further comprising:
adjusting a position of the guide pins in an array of pegboard holes in the first plate for different size keyboard models.

20. The method of claim 19 wherein fastening the multiple internal layers together comprises inserting screws through holes in the array of pegboard holes in the first plate and through holes in the multiple internal layers.
